(19) United States
(12) Patent Application Publication
(10) Pub. No.: US 2012/0019502 A1
(43) Pub. Date: Jan. 26, 2012

(54) SOURCE DRIVER FOR A LIQUID CRYSTAL DISPLAY DEVICE AND LIQUID CRYSTAL DISPLAY DEVICE USING THE SAME

(75) Inventor: Hirokazu KAWAGOSHI, Kanagawa (JP)

(73) Assignee: Renesas Electronis Corporation

(21) Appl. No.: 13/161,027

(22) Filed: Jun. 15, 2011

(30) Foreign Application Priority Data
Jul. 21, 2010 (JP) 2010-163938

(51) Int. Cl. G09G 5/00

(52) U.S. Cl. 345/211

(57) ABSTRACT

In a source driver for a liquid crystal display device, a slew rate is increased while an increase in power consumption is suppressed. The source driver for a liquid crystal display device includes multiple output amplifiers that drive multiple data lines in response to an input signal, and a bias control circuit having a dummy amplifier consistent with an electric characteristic of the output amplifiers. The bias control circuit controls high bias periods of the output amplifiers on the basis of an output transition period of the dummy amplifier when the dummy amplifier receives voltages of a γ resistor circuit, which are input to the output amplifiers.

### CROSS-REFERENCE TO RELATED APPLICATIONS

The disclosure of Japanese Patent Application No. 2010-163938 filed on Jul. 21, 2010 including the specification, drawings and abstract is incorporated herein by reference in its entirety.

### BACKGROUND

The present invention relates to a source driver for a liquid crystal display and a liquid crystal display using the same.

In recent years, a larger screen and a higher definition of the liquid crystal display devices used for televisions or personal computer displays have been advanced. With such advancement, a performance for driving a larger load at a higher speed while suppressing power consumption is required for the source driver of the liquid crystal display device. In addition, a large number of differential amplifier circuits are mounted on the source driver. For that reason, a higher slew rate is required while giving rise to no increase in a chip area and no increase in the power consumption. Also, there is a need to pay attention to an increase in a deviation of driving performances of the respective amplifier circuits.

Japanese Unexamined Patent Application Publication No. 2001-156559 (corresponding U.S. Pat. No. 6,392,485 (B1)) discloses a high slew rate differential amplifier circuit. FIG. 1 is a circuit diagram illustrating a configuration of the differential amplifier circuit disclosed in Japanese Unexamined Patent Application Publication No. 2001-156559. The differential amplifier circuit is directed to a rail-to-rail differential amplifier circuit, which includes a p-MOS differential input part 101, a p-MOS sub-current source 106, an n-MOS differential input part 102, an n-MOS sub-current source 107, a current mirror circuit 103, a current mirror circuit 104, and a push-pull output stage 105. The p-MOS differential input part 101 includes transistors M1, M2, and M3. The p-MOS sub-current source 106 includes transistors M17 and M18. The n-MOS differential input part 102 includes transistors M4, M5, and M6. The n-MOS sub-current source 107 includes transistors M19 and M20. The current mirror circuit 103 includes transistors M7, M8, M9, and M10. The current mirror circuit 104 includes transistors M11, M12, M13, and M14. The push-pull output stage 105 includes transistors M15 and M16. Vdd is a positive supply voltage Vss, and Vss is a negative supply voltage.

A non-inverting input Vin(+) is coupled to gates of the transistors M3 and M5, and an inverting input Vin(−) is coupled to gates of the transistors M2 and M4. Outputs of the p-MOS differential input part 101 from the transistors M2 and M3 are input to the current mirror circuit 104, and outputs of the n-MOS differential input part 102 from the transistors M4 and M5 are input to the current mirror circuit 103. The current mirror circuit 103 and the current mirror circuit 104 are coupled to each other by resistors R1 and R2. A gate of the transistor M15 in the push-pull output stage 105 is coupled to a connection point between the transistor M10 and one end of the resistor R2, and a gate of the transistor M16 in the push-pull output stage 105 is coupled to a connection point between the transistor M12 and the other end of the resistor R2. Also, the resistors R1 and R2 can be each formed of a MOS transistor. The p-MOS sub-current source 106 is configured by connecting a current source circuit in parallel to the constant current source transistor M1 of the p-MOS differential input part 101. In the current source circuit, the constant current source transistor M17 is coupled in series with the transistor M18 having a gate to which a gate voltage of the p-MOS output transistor M15 is input. The n-MOS sub-current source 107 is configured by connecting a current source circuit in parallel to the constant current source transistor M6 of the n-MOS differential input part 102. In the current source circuit, the constant current source transistor M20 is coupled in series with the transistor M19 having a gate to which a gate voltage of the n-MOS output transistor M16 is input. C1 and C2 are phase compensation capacitors, and Vb1 to Vb4 are bias voltages set to appropriately operate the respective transistors. In this example, an external load CL is coupled between an output of the push-pull output stage 105 and the negative supply voltage Vss.

In the differential amplifier circuit (source driver of the liquid crystal display device), the inverting input voltage (Vin−) and the amplifier output terminal Vout are short-circuited and used as one-time amplifier. In the operation of the differential amplifier circuit, when the amplifier output terminal Vout transits from a lower voltage to a higher voltage, a voltage across a node PG41 instantaneously drops to turn on the transistor M18. Also, a constant current (the constant current sources M1, M17) of the input differential stage (p-MOS differential input part 101 and p-MOS sub-current source 106) instantaneously increases to provide a higher slew rate. When the amplifier output terminal Vout transits from the higher voltage to the lower voltage, a voltage across the node NG41 instantaneously increases to turn on the transistor M19, and a constant current (the constant current sources M6, M20) of the input differential stage (the n-MOS differential input part 102 and the n-MOS sub-current source 107) instantaneously increases to provide a higher slew rate.

As a related art, Japanese Unexamined Patent Application Publication No. 2004-78216 (corresponding U.S. Pat. No. 7,317,440 (B2)) discloses a circuit for driving a liquid crystal display device with a low electric power, and a method thereof. A driver circuit for driving the liquid crystal display device includes a previous-data latch, a bias control voltage generator, and a driver amplifier. The previous-data latch receives a part or all of display data to output the data as previous data. The bias control voltage generator compares the present data of the display data with the previous data to generate a control signal. The driver amplifier receives an input voltage to generate an output voltage, and adjusts the slew rate in response to the control signal.

Also, as the related art, Japanese Unexamined Patent Application Publication No. 2004-32603 (corresponding U.S. Patent No. 6,897,726(B2)) discloses a differential circuit, an amplifier circuit, and a display device using the amplifier circuit. The differential circuit includes a first differential pair, a second differential pair, a first load circuit, a second load circuit, a communication unit, a first output, a second output, and a changeover unit. The first differential pair is a first conduction type that is driven by a first constant current source, and receives first and second input voltages from a differential input pair. The second differential pair is a second conduction type that is driven by a second constant current source, and receives the first and second input voltages from the differential input pair. The first load circuit is configured by a second conductive transistor that is coupled to a first power supply and forms a positive load of the first differential pair. The second load circuit is configured by a first conductive transistor that is coupled to a second power supply and forms a positive load of the second differential pair. The communication unit can communicate between the first load circuit and the second load circuit, and allows a current to flow from at least one of the first and second load circuits to the other. The first output is output from the first load circuit. The second output is output from the second load circuit. The changeover unit switches between a first connection state in which the first output is active, and the second output is inactive, and a second connection state in which the second output is active, and the first output is inactive.

### SUMMARY

It has become first apparent from the study of the present inventors that the operation of the differential amplifier circuit disclosed in Japanese Unexamined Patent Application Publication No. 2001-156559 suffers from the following problems. FIGS. 2A to 2D are timing charts showing the operation of the differential amplifier circuit disclosed in Japanese Unexamined Patent Application Publication No. 2001-156559. FIG. 2A shows a strobe signal STB that conducts control so that an amplifier output is coupled to an output terminal at a low level, and the output terminal becomes high impedance at a high level. FIG. 2B shows a voltage across a node PG41, FIG. 2C shows a voltage across the node NG41, and FIG. 2D shows a voltage across the amplifier output terminal Vout. A voltage (d) across the amplifier output terminal Vout is increased in speed and transited at input timing of the strobe signal STB(a).

When the voltage (d) across the amplifier output terminal Vout transits from a lower voltage to a higher voltage, the voltage across the node PG41 drops (−ΔV) to increase a transition speed of the voltage (d) across the amplifier output terminal Vout. However, in the operation of the circuit, a drop time of the node PG41 is very long (tbp1=about 10 μs). That is, a constant current value of the input differential stage (the p-MOS differential input part 101 and the p-MOS sub-current source 106) increases for a long time. For that reason, it is conceivable that a ringing waveform Q1 appears in the voltage (d) across the amplifier output terminal Vout, and the input differential stage draws in all current in an intermediate stage (the current mirror circuits 103, 104, and the resistors R1, R2), thereby falling into oscillation operation as abnormal operation.

Similarly, when the voltage (d) across the amplifier output terminal Vout transits from the higher voltage to the lower voltage, the same condition as described above occurs. That is, in that case, the voltage across the node NG41 increases (+ΔV) to increase the transition speed of the voltage (d) across the amplifier output terminal Vout. However, in the operation of the circuit, an up time of the node NG41 is very long (tbn1=about 10 μs). That is, the constant current value of the input differential stage (n-NOS differential input part 102 and the n-MOS sub-current source 107) is increased for a long time. For that reason, it is conceivable that a ringing waveform Q2 appears in the voltage (d) across the amplifier output terminal Vout, and the input differential stage draws in all current in an intermediate stage (the current mirror circuits 103, 104, and the resistors R1, R2), thereby falling into oscillation operation as abnormal operation.

Further, after the transition operation of the voltage across the amplifier output terminal Vout, the differential amplifier circuit returns to stationary operation. For that reason, voltage remains such that the gate voltage across the transistor M18 is substantially equal to Vdd−V_{TP}, and the gate voltage across the transistor M19 is substantially equal to Vdd−V_{TN}. Accordingly, it is very difficult to design the sizes (W/L) of the transistor M18 and the transistor M19 because the transistor M18 and the transistor M19 must be turned off in that state. In this example, V_{TP} and V_{TN} are threshold voltages of the transistors M18 and M19, respectively.

Hereinafter, means for solving the problem will be described with the use of numeral references and symbols used for the embodiment of the present invention. Those numeral references and symbols are parenthetically added for the purpose of clarifying a correspondence relationship between the definitions of claims and the embodiments of the invention. Those numeral references and symbols must not be used for interpreting the technical field of the invention defined in the claims.

According to one aspect of the present invention, there is provided a source driver (98) for a liquid crystal display device, including multiple output amplifiers (22a, 22b) that drive multiple data lines (92) in response to an input signal; and a bias control circuit (13) having a dummy amplifier (32/32a, 32b) consistent with an electric characteristic of the output amplifiers (22a, 22b). The bias control circuit (13) controls a period (t2 to t3, t6 to t7), during which the output amplifiers (22a, 22b) are set to high biases, on the basis of a transition period (t1 to t4, t5 to t8) of an output (AMPD11_OUT/AMPD31_OUT, AMPD32_OUT) from the dummy amplifier (32/32a, 32b) when the dummy amplifier (32/32a, 32b) receives voltages (V1/V3) of a γ resistor circuit, which are input to the output amplifiers (22a, 22b).

The source driver (98) according to the aspect of the present invention controls the periods (t2 to t3, t6 to t7) during which the output amplifiers (22a, 22b) are set to the high bias (high bias currents) in correspondence with the transition periods (t1 to t4, t5 to t8) of the output (AMPD11_OUT/AMPD31_OUT, AMPD32_OUT) from the dummy amplifier (32/32a, 32b) in the operation of the output amplifiers (22a, 22b). In this situation, the dummy amplifier (32/32a, 32b) is consistent with the electric characteristic of the output amplifiers (22a, 22b). For that reason, the bias currents in the output amplifiers (22a, 22b) increase so as to provide the higher slew rate during only the periods (t2 to t3, t6 to t7) following the output transition of the output amplifiers (22a, 22b). That is, substantially necessary and sufficient high bias control can be realized. Also, since the periods (t2 to t3, t6 to t7) during which the bias current increases are limited, an increase in the dynamic power consumption caused by the higher slew rate can be suppressed.

According to another aspect of the present invention, there is provided a liquid crystal display device (90) for the liquid crystal display device, multiple data lines (92) driven by the source driver (98) for the liquid crystal display device, and multiple pixels (99) coupled to the data lines (92). Similarly, in this case, since the source driver (98) is used, the higher slew rate can be provided while an increase in the dynamic power consumption is suppressed.

According to the present invention, in the source driver for the liquid crystal display device, the higher slew rate amplifier that stably operates can be realized by a circuit easy in design of a circuit constant.

### BRIEF DESCRIPTION OF THE DRAWINGS

FIG. 1 is a circuit diagram illustrating a configuration of a differential amplifier circuit disclosed in Japanese Unexamined Patent Application Publication 2001-156559;

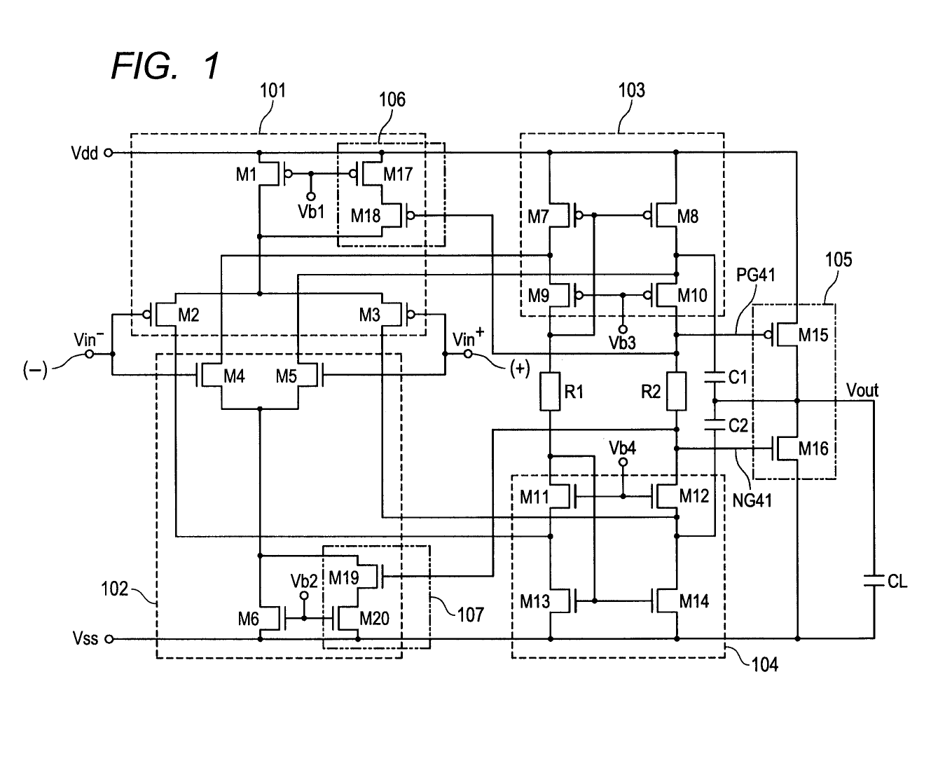

FIGS. 2A to 2D are timing charts showing the operation of the differential amplifier circuit disclosed in Japanese Unexamined Patent Application Publication 2001-156559;

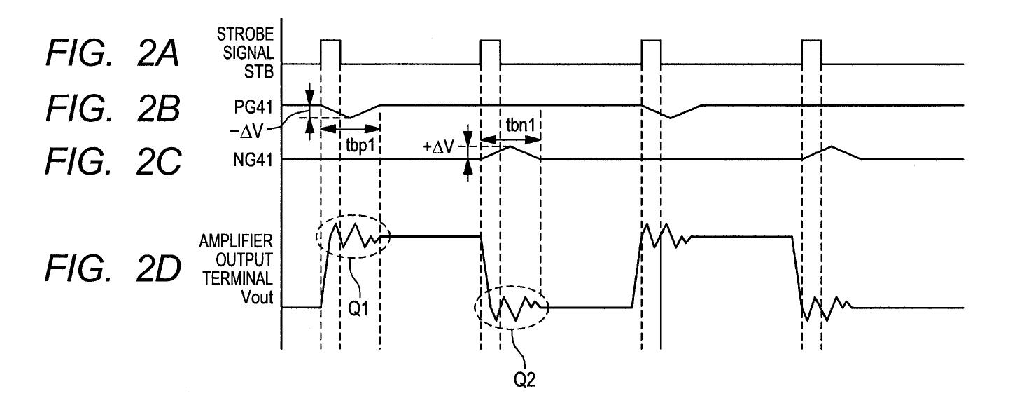

FIG. 3 is a block diagram illustrating a configuration of a liquid crystal display device according to a first embodiment of the present invention;

FIG. 4A is a block diagram illustrating an example of a configuration of a source driver in the liquid crystal display device according to the first embodiment of the present invention;

FIG. 4B is a schematic diagram illustrating an example of the configuration of the source driver in the liquid crystal display device according to the first embodiment of the present invention;

FIG. 5 is a circuit diagram illustrating an example of a configuration of an output amplifier according to the first embodiment of the present invention;

FIGS. 6A to 6F are timing charts showing an example of operation of the source driver in the liquid crystal display device according to the first embodiment of the present invention;

FIG. 7 is a graph showing an initial waveform of a transient characteristic of an output amplifier with a load and an initial waveform of a transient characteristic of a dummy amplifier with no load; and

FIG. 8 is a block diagram illustrating an example of a configuration of a source driver in a liquid crystal display device according to a second embodiment of the present invention.

### DETAILED DESCRIPTION

Hereinafter, a description will be given of a source driver for a liquid crystal display device, and the liquid crystal display device using the source driver according to an embodiment of the present invention with reference to the accompanying drawings.

### First Embodiment

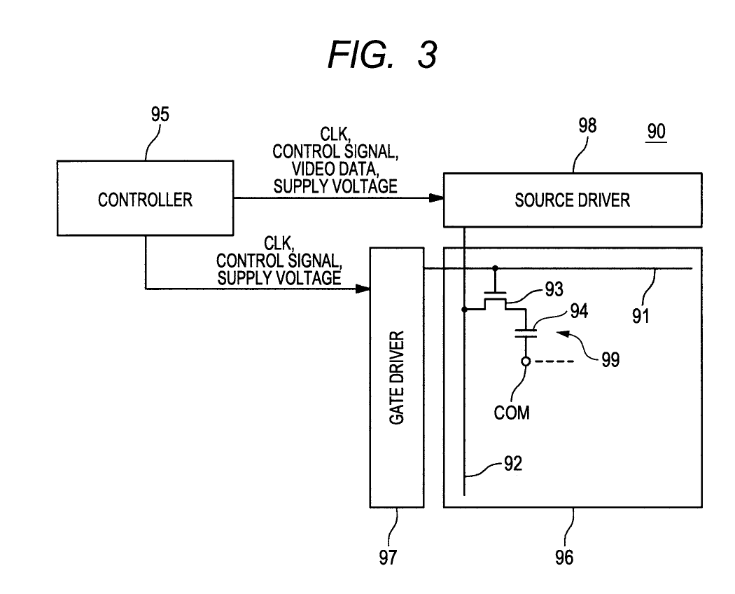

A description will be given of a source driver for a liquid crystal display device and the liquid crystal display device using the source driver according to an embodiment of the present invention. FIG. 3 is a block diagram illustrating a configuration of a liquid crystal display device according to a first embodiment of the present invention. A liquid crystal device 90 includes a controller 95, a liquid crystal panel 96, a gate driver 97, and a source driver 98.

The controller 95 outputs a clock signal (CLK), a control signal, and a supply voltage to the gate driver 97, and the clock signal (CLK), the control signal, video data, and the supply voltage to the source driver 98, respectively. The gate driver 97 operates in synchronism with the clock signal upon application of the supply voltage. The gate driver 97 drives multiple gate lines 91 in the liquid crystal panel 96 on the basis of the control signal and the video data. The gate driver 97 may be integrated with the controller 95. In this case, the circuit area can be reduced. The source driver 98 operates in synchronism with the clock signal upon application of the supply voltage. The source driver 98 drives multiple data lines 92 in the liquid crystal panel 96 on the basis of the control signal and the video data. The source driver 98 may be integrated with the controller 95. In this case, the circuit area can be reduced.

The liquid crystal panel 96 includes the gate lines 91, the data lines 92, and multiple pixels 99. The gate lines 91 extend in parallel to each other in a first direction. The data lines 92 extend in parallel to each other in a second direction perpendicular to the first direction. The pixels 99 are arranged in a matrix in the vicinity of intersections of the gate lines 91 and the data lines 92. Each of the pixels 99 includes a transistor 93 and a pixel capacitor 94 having liquid crystal. The transistor 93 has a gate coupled to each gate line 91, one of a source and a drain coupled to each data line 92, and the other coupled to one terminal of the pixel capacitor 94. An opposing substrate voltage VCOM is applied to the other COM terminal of the pixel capacitor 94. A gradation voltage of the pixel capacitor 94 is controlled by driving each data line 92 through the source driver 98. The on/off operation of the transistor 93 is controlled by driving each gate line 91 through the gate driver 97. In the liquid crystal panel 96, the gate lines 91 and the data lines 92 are driven by the gate driver 97 and the source driver 98 to display an image corresponding to video data on the pixels 99. As the liquid crystal device 90, a general configuration can be applied other than the source driver 98.

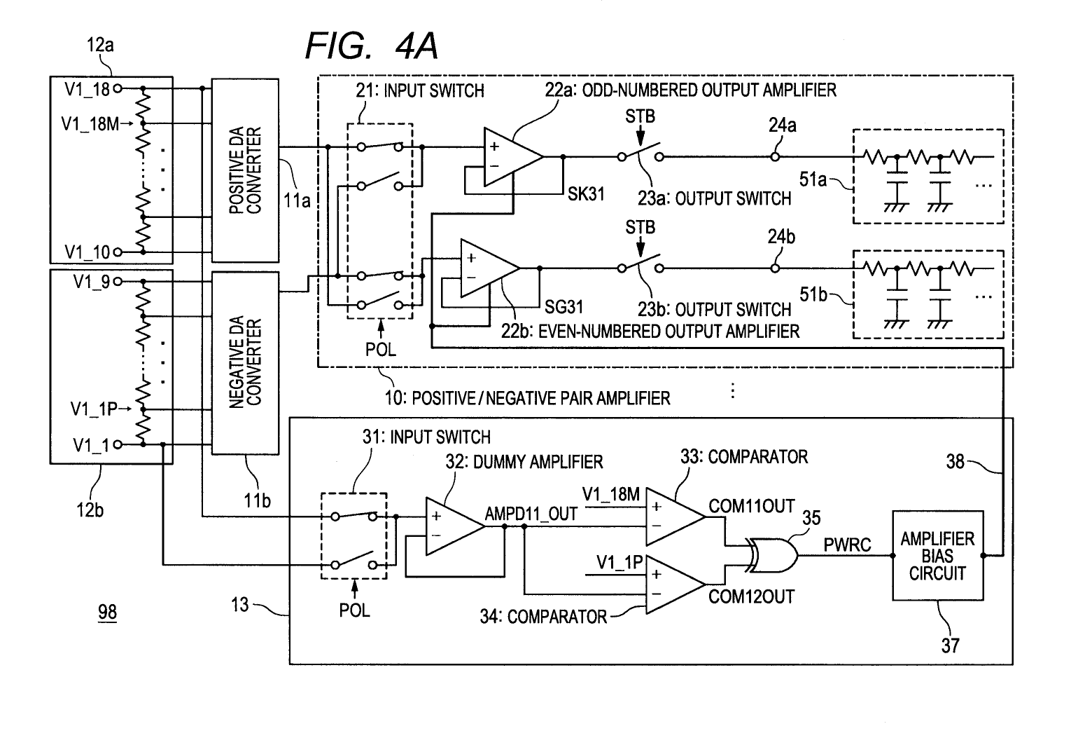

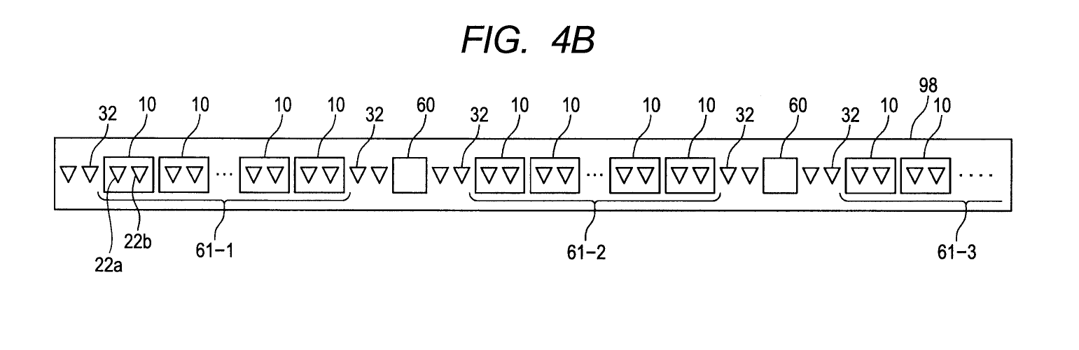

Subsequently, the source driver 98 will be described. FIG. 4A is a block diagram illustrating an example of a configuration of a source driver in the liquid crystal display device according to the first embodiment of the present invention. The source driver 98 is a source driver IC (integrated circuit), and includes a positive γ resistor circuit 12a, a negative γ resistor circuit 12b, a positive DA converter 11a, a negative DA converter 11b, a positive/negative pair amplifier 10, and a bias control circuit 13. FIG. 4A illustrates one positive/negative pair amplifier 10 having each odd output amplifier 22a for the odd-numbered data lines 92 and each even output amplifier 22b for the even-numbered data lines 92, together with related circuits, in the case of dot inverting operation.

The positive γ resistor circuit 12a is applied with at least two gamma voltages (exemplification: V1_10, V1_18) from a positive polarity γ correction circuit (not shown), and generates multiple positive reference voltages V1_10 to V1_18 by voltage division. The negative γ resistor circuit 12b is applied with at least two gamma voltages (exemplification: V1_1, V1_9) from a negative polarity γ correction circuit (not shown), and generates multiple negative reference voltages V1_1 to V1_9 by voltage division. The positive DA converter 11a selects a positive reference voltage corresponding to the input video data on the basis of the positive reference voltages applied from the positive γ resistor circuit 12a, and outputs the selected positive reference voltage to the positive/negative pair amplifier 10. The negative DA converter 11b selects a negative reference voltage corresponding to the input video data on the basis of the negative reference voltages applied from the negative γ resistor circuit 12b, and outputs the selected negative reference voltage to the positive/negative pair amplifier 10.

The positive/negative pair amplifier 10 includes an input switch 21, an output amplifier 22 (odd-numbered output amplifier 22a, even-numbered output amplifier 22b), output switches 23a, 23b, and output terminals 24a, 24b. The input switch 21 outputs one of the selected positive reference voltage and negative reference voltage to a non-inverting input terminal (+) of the odd-numbered output amplifier 22a, and the other reference voltage to a non-inverting input terminal (+) of the even-numbered output amplifier 22b, selectively according to a polarity inverting control signal POL, respectively. The odd-numbered output amplifier 22a and the even-numbered output amplifier 22b have output terminals SK31 and SG31 coupled to inverting input terminals (−) thereof, respectively. The odd-numbered output amplifier 22a and the even-numbered output amplifier 22b operationally amplify the positive reference voltage and the negative reference voltage applied thereto, respectively. The odd-numbered output amplifier 22a and the even-numbered output amplifier 22b then output those results as outputs SKOUT11 and SGOUT11 to display panel loads 51a and 51b (corresponding to the liquid crystal panels 96) from the output terminals 24a and 24b through the output switches 23a and 23b. The output switches 23a and 23b are controlled according to the strobe signal STB (a signal that conducts control so that the amplifier output is coupled to the output terminal at a low level, and the output terminal becomes high impedance at a high level). The odd-numbered output amplifier 22a and the even-numbered output amplifier 22b have the bias voltages controlled by the bias control circuit 13. The odd-numbered output amplifier 22a and the even-numbered output amplifier 22b are substantially identical in the electric characteristic and structure (layout) with each other.

The bias control circuit 13 controls multiple bias voltages to be applied to the odd-numbered output amplifier 22a and the even-numbered output amplifier 22b on the basis of the reference voltages from the positive γ resistor circuit 12a and the negative γ resistor circuit 12b, and the polarity inverting control signal POL from the controller 95. The bias control circuit 13 includes an input switch 31, a dummy amplifier 32, comparators 33, 34, an EXOR circuit 35, and an amplifier bias circuit 37.

The input switch 31 is applied with the highest voltage V1_18 among the reference voltages of the positive γ resistor circuit 12a, and the lowest voltage V1_1 among the reference voltages of the negative γ resistor circuit 12b. The input switch 31 alternately outputs the highest voltage V1_18 and the lowest voltage V1_1 to the non-inverting input terminal (+) of the dummy amplifier 32, switchingly in the cycle of the polarity inverting control signal POL.

The dummy amplifier 32 is alternately applied with the highest voltage V1_18 and the lowest voltage V1_1 in the cycle of the polarity inverting control signal POL. The dummy amplifier 32 operationally amplifies the applied voltage, and outputs a resultant output AMPD11_OUT to inverting input terminals (−) of the comparators 33 and 34. The dummy amplifier 32 has an output terminal coupled to the inverting input terminal (−) thereof. Because of a reason that will be described later, the dummy amplifier 32 has the electric characteristic consistent with that of the output amplifier 22 (the odd-numbered output amplifier 22a, the even-numbered output amplifier 22b). The consistent electric characteristic means that the states (period and waveform) of the output transition that will be described later are substantially identical with each other. In order to provide the consistent electric characteristic, it is preferable that the dummy amplifier 32 has substantially the same structure (layout) as that of the output amplifier 22. In addition, it is more preferable that the dummy amplifier 32 is disposed in the vicinity of the output amplifier 22. The wording “substantially the same” means the same within a range of the manufacturing error, for example.

The comparator 33 has an inverting input terminal (−) applied with an output of the dummy amplifier 32, and a non-inverting input terminal (+) applied with a voltage V1_18M slightly lower than the highest voltage V1_18, respectively. The comparator 33 then outputs an output COM11OUT as the comparison result to one input of the EXOR circuit 35. On the other hand, the comparator 34 has an inverting input terminal (−) applied with an output of the dummy amplifier 32, and a non-inverting input terminal (+) applied with a voltage V1_1P slightly higher than the lowest voltage V1_1, respectively. The comparator 34 then outputs an output COM12OUT as the comparison result to the other input of the EXOR circuit 35.

The EXOR circuit 35 has two inputs, and is applied with the outputs COM11OUT and COM12OUT of the comparators 33 and 34. The EXOR circuit 35 executes EXORing of the outputs COM11OUT and COM12OUT, and outputs a resultant output PWRC to the amplifier bias circuit 37.

When the output AMPD11_OUT of the dummy amplifier 32 is between the voltage V1_18M and V1_1P, that is, when the output COM11OUT is high level, the output COM12OUT is low level, and therefore the output PWRC is high level, the amplifier bias circuit 37 controls the bias of the odd-numbered output amplifier 22a and the even-numbered output amplifier 22b to be high. On the other hand, the output AMPD11_OUT of the dummy amplifier 32 is larger than the voltage V1_18M, or smaller than the voltage V1_1P, that is, when the output COM11OUT is low level and the output COM12OUT is low level, or the output COM11OUT is high level and the output COM12OUT is high level, and therefore the output PWRC is low level, the amplifier bias circuit 37 controls the bias of the odd-numbered output amplifier 22a and the even-numbered output amplifier 22b to be low. This operation is a dot inversion.

It is preferable to use, as the dummy amplifier 32, the dummy amplifier which is arranged at both ends of an output amplifier array for the purpose of preventing a deviation enlargement caused by the output amplifier array of the source driver part. The dummy amplifier is entirely identical in circuit configuration and layout configuration with the output amplifier 22. That is, the dummy amplifier has the same electric characteristic as that of the output amplifier 22. Further, the dummy amplifier is disposed in the vicinity of the output amplifier 22. In addition, the dummy amplifier is effectively used to suppress an increase in the circuit area. Such a dummy amplifier will be described in detail.

FIG. 4B is a schematic diagram illustrating an example of the configuration of the source driver in the liquid crystal display device according to the first embodiment of the present invention. The normal source driver 98 is arranged so that several hundreds of positive/negative pair amplifiers 10 (the odd-numbered output amplifiers 22a and the even-numbered output amplifiers 22b) are arrayed. For example, in the case of the source driver of 960 outputs (480 odd-numbered output amplifiers 22a and 480 even-numbered output amplifiers 22b), 240 outputs (120 odd-numbered output amplifiers 22a and 120 even-numbered output amplifiers 22b)×4 blocks are arranged. In this case, it is conceivable that, for example, a circuit 60 (exemplification: control circuit) is disposed between a 240th output (belonging to the positive/negative pair amplifier 10 of a first block 61-1) and a 241st output (belonging to the positive/negative pair amplifier 10 of a second block 61-2), that is, between the blocks. In this example, within each block 61, the adjacent elements are the output amplifier 22 (the odd-numbered output amplifier 22a and the even-numbered output amplifier 22b), and the layouts are substantially identical with each other. For that reason, the uniformity is kept from the manufacturing viewpoint, and a low deviation in the performance between the elements can be kept. However, the different circuit 60 is adjacent to the output amplifiers 22 between the blocks 61, and the adjacent layout is different. For that reason, the uniformity is not kept from the manufacturing viewpoint, which may cause an increase in the deviation of the performance between the elements. Accordingly, it is preferable that the dummy amplifier having substantially the same layout as that of the output amplifier 22 is arranged between the blocks 61, that is, between the output amplifiers 22. With this arrangement, a low deviation in the performance between the output amplifiers 22, in particular, the low deviation at the block ends can be kept.

In this embodiment, it is preferable that the dummy amplifier disposed between the blocks 61 operates as the dummy amplifier 32 which is an element of the bias control circuit 13. In this case, the output amplifier 22 (the odd-numbered output amplifier 22a and the even-numbered output amplifier 22b) is substantially identical in the layout (and the electric characteristic) with the dummy amplifier 32. Therefore, assuming that the rising and falling periods of the voltage across the dummy amplifier 32 is substantially equal to the rising and falling periods of the voltage across the output amplifier 22, a “period” (a period during which the bias current of the output amplifier 22 increases) for controlling the slew rate of the output amplifier 22 is determined. Also, with the provision of the dummy amplifier 32 in the vicinity of the output amplifier 22, a “period” following the manufacturing variation of the output amplifier 22 can be created assuming that the manufacturing variation of the dummy amplifier 32 reflects the manufacturing variation of the output amplifier 22.

With the above circuit configuration, only in a period where the output AMPD11_OUT of the dummy amplifier 32 is between the voltage V1_18M and the voltage V1_1P, that is, in a time during which the output of the output amplifier 22 (the odd-numbered output amplifier 22a and the even-numbered output amplifier 22b) transits, the bias current of the output amplifier 22 can increase. In this situation, the dummy amplifier 32 can be used to control the slew rate following the manufacturing variation of the slew rate of the output amplifier 22 or a change in the slew rate due to the bias adjustment, that is, to create a time for accurately increasing the bias current only during the period where the output of the output amplifier 22 transits without being affected by the manufacturing variation.

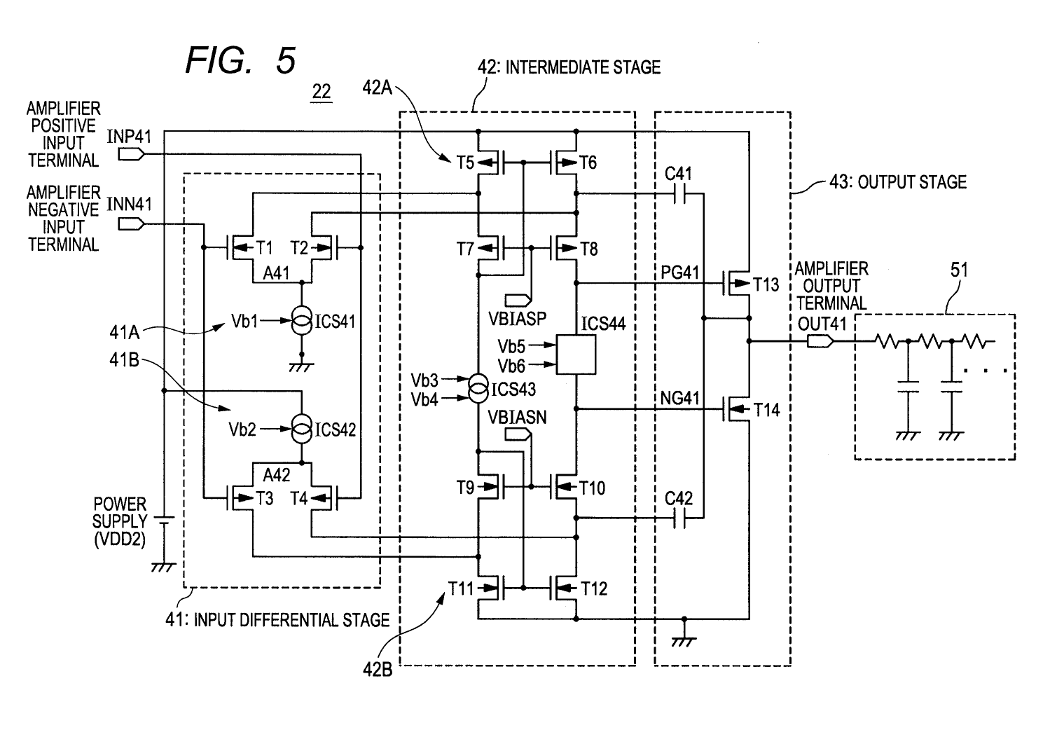

Subsequently, the configuration of the output amplifier 22 (the odd-numbered output amplifier 22a and the even-numbered output amplifier 22b) will be described. FIG. 5 is a circuit diagram illustrating an example of a configuration of an output amplifier according to the first embodiment of the present invention. The output amplifier exemplified in FIG. 5 is a rail-to-rail differential amplifier circuit including an input differential stage 41, an intermediate stage 42, and an output stage 43.

The input differential stage 41 includes input differential stages 41A and 41B. The input differential stage 41A includes a constant current source ICS41 and an Nch differential pair (T1, T2). The constant current source ICS41 has a first terminal coupled to the ground. An output pair of the Nch differential pair (T1, T2) is coupled to a current mirror circuit 42A of the intermediate stage 42. The Nch differential pair (T1, T2) has a positive input terminal INP41=non-inverting input terminal (+) coupled to the gate of the transistor T2, and a negative input terminal INN41=non-inverting input terminal (−) coupled to the gate of the transistor T1. The constant current source ICS41 is applied with a bias voltage Vb1 for the constant current source ICS41, and the amount of current is controlled.

The input differential stage 41B includes a constant current source ICS42 and a Pch differential pair (T3, T4). The constant current source ICS42 has a first terminal coupled to a supply voltage VDD2. The Pch differential pair (T3, T4) has a common source coupled to a second terminal of the constant current source ICS42. An output pair of the Pch differential pair (T3, T4) is coupled to a current mirror circuit 42B of the intermediate stage 42. The Pch differential pair (T3, T4) has a positive input terminal INP41=non-inverting input terminal (+) coupled to the gate of the transistor T4, and a negative input terminal INN41=non-inverting input terminal (−) coupled to the gate of the transistor T3. The constant current source ICS42 is applied with a bias voltage Vb2 for the constant current source ICS42, and the amount of current is controlled.

The intermediate stage 42 includes the current mirror circuit 42A, the current mirror circuit 42B, a constant current source ICS43, and a floating current source ICS44. The constant current source ICS43 is applied with bias voltages Vb3 and Vb4 for the constant current source ICS43 from the amplifier bias circuit 37, and the amount of current is controlled. The floating current source ICS 44 is applied with bias voltages Vb5 and Vb6 for the floating current source ICS44 from the amplifier bias circuit 37, and the amount of current is controlled.

The current mirror circuit 42A includes the transistors T5, T6, T7, and T8. The transistors T5 and T6 (both transistors are Pch) have gates coupled to each other, sources coupled to a supply voltage VDD2, and drains coupled to sources of the respective transistors T7 and T8. The transistors T7 and T8 (both transistors are Pch) have gates coupled to each other, and drains coupled to one ends of the respective constant current source ICS43 and floating current source ICS44. The transistors T5 and T6 further have gates coupled to the drain of the transistor T7, and drains coupled to the output pair of the Nch differential pair (T1, T2). In the current mirror circuit 42A, a bias voltage VBIASP for the current mirror circuit 42A is applied to the gates of the transistors T7 and T8 from the amplifier bias circuit 37, and the amount of current is controlled.

The current mirror circuit 42B includes transistors T9, T10, T11, and T12. The transistors T11 and T12 (both transistors are Nch) have gates coupled to each other, sources coupled to the ground, and drains coupled to the sources of the respective transistors T9 and T10. The transistors T9 and T10 (both transistors are Nch) have gates coupled to each other, and drains coupled to the other ends of the respective constant current source ICS43 and floating current source ICS44. The transistors T11 and T12 further have gates coupled to the drain of the transistor T9, and drains coupled to the output pair of the Pch differential pair (T3, T4). In the current mirror circuit 42B, a bias voltage VBIASN for the current mirror circuit 42B is applied to the gates of the transistors T9 and T10 from the amplifier bias circuit 37, and the amount of current is controlled.

The output stage 43 is a push-pull output stage including transistors T13 (Pch) and T14 (Nch). The transistor T13 has a gate coupled to a connection point between an output terminal (a drain side of T8) of the current mirror circuit 42A and one end of the floating current source ICS44, a source coupled to the supply voltage VDD2, and a drain coupled to an amplifier output terminal OUT41. The transistor T13 has charging operation. The transistor T14 has a gate coupled to a connection point between an output terminal (a drain side of T10) of the current mirror circuit 42B and the other end of the floating current source ICS44, a source coupled to the ground, and a drain coupled to the amplifier output terminal OUT41. The transistor T14 has discharging operation. A phase compensation capacitor C41 has one end coupled to a drain of the transistor T6, and the other end coupled to the amplifier output terminal OUT41, respectively. A phase compensation capacitor C42 has one end coupled to a drain of the transistor T12 and the other end coupled to the amplifier output terminal OUT41, respectively. The amplifier output terminal OUT41 is coupled to a display panel load 51 (corresponding to the liquid crystal panel 96) through an output switch and so on (not shown).

When the amplifier positive input terminal INP41 (non-inverting input (+)) changes from the lower voltage to the higher voltage, most of current flows in the transistor T3 in the input differential stage 41B, and a current flowing in the transistor T11 increases. For that reason, a current flowing in the transistors T10 and T12 also increases due to the current mirror circuit 42B, and a gate voltage across the transistor T14 decreases. A current flowing in the transistor T14 decreases, and a sink current of the display panel load 51 decreases. On the other hand, most of current flows in the transistor T2 in the input differential stage 41A, and a current flowing in the transistor T8 decreases. For that reason, a gate voltage across the transistor T13 decreases, a current flowing in the transistor T13 increases, to allow the display panel load 51 to be charged. As a result, the display panel load 51 is charged, and an output voltage across an amplifier output terminal UT41 increases.

In this situation, the amplifier bias circuit 37 controls Vb1 to Vb6, VBIASP, and VBIASN so that currents in the constant current sources ICS41, ICS42, ICS43, the floating current source ICS44, and the current mirror circuits 42A, and 42B increase as compared with a normal case (exemplification: 200% with respect to 100% in the normal operation). For example, the amplifier bias circuit 37 outputs Vb1₀, Vb2₀, Vb3₀, Vb4₀, Vb5₀, Vb6₀, VBIASP₀, and VBIASN₀ in the normal operation, and outputs Vb1₁, Vb2₁, Vb3₁, Vb4₁, Vb5₁, Vb6₁, VBIASP₁, and VBIASN₁ when the voltage changes.

As a result, the current flowing in the transistor T3 increases more, the current flowing in the transistor T11 increases more, and the currents flowing in the transistors T10 and T12 also increase more due to the current mirror circuit 42B. The gate voltages across the transistors T13 and T14 decrease more quickly, and the current flowing in the transistor T13 increases more. The display panel load 51 is rapidly charged, and the output voltage across the amplifier output terminal UT41 more rapidly increases. Accordingly, the slew rate can be improved.

Also, when the amplifier positive input terminal INP41 (non-inverting input (+)) changes from the higher voltage to the lower voltage, most of current flows in the transistor T4 in the input differential stage 41B, and a current flowing in the transistor T10 decreases. For that reason, a gate voltage across the transistor T14 increases, a current flowing in the transistor T14 increases, and a sink current of the display panel load 51 increases. On the other hand, most of current flows in the transistor T1 in the input differential stage 41A, and a current flowing in the transistors T5 and T7 increases. For that reason, a current flowing in the transistors T6 and T8 also increases due to the current mirror circuit 42A, a gate voltage across the transistor T15 increases, a current flowing in the transistor T15 decreases, and a charging rate of the display panel load 51 decreases. As a result, the display panel load 51 is charged, and an output voltage Vout decreases.

In this situation, the amplifier bias circuit 37 controls Vb1 to Vb6, VBIASP, and VBIASN so that currents in the constant current sources ICS41, ICS42, ICS43, the floating current source ICS44, and the current mirror circuits 42A, and 42B increase as compared with a normal case (exemplification: 200% with respect to 100% in the normal operation). For example, the amplifier bias circuit 37 outputs Vb1₀, Vb2₀, Vb3₀, Vb4₀, Vb5₀, Vb6₀, VBIASP₀, and VBIASN₀ in the normal operation, and outputs Vb1₁, Vb2₁, Vb3₁, Vb4₁, Vb5₁, Vb6₁, VBIASP₁, and VBIASN₁ when the voltage changes.

As a result, the current flowing in the transistor T1 increases more, the current flowing in the transistor T5 increases more, and the currents flowing in the transistors T6 and T8 also increase more due to the current mirror circuit 42A. The gate voltages across the transistors T13 and T14 increase more quickly, and the current flowing in the transistor T14 increases more. The display panel load 51 is rapidly charged, and the output voltage across the amplifier output terminal UT41 more rapidly decreases. Accordingly, the slew rate can be improved.

As described above, the bias control circuit 13 (amplifier bias circuit 37) increases the currents in the constant current sources ICS41, 42, 43, the floating current source ICS44, and the current mirror circuits 42A, and 42B in the output amplifier 22 (odd-numbered output amplifier 22a and the even-numbered output amplifier 22b). As a result, the bias control circuit 13 can rapidly increase or decrease the output voltage of the amplifier output terminal OUT41 as compared with a case in which no current increases. That is, the slew rate can be improved.

The constant current sources ICS41, 42, 43, and the floating current source ICS44 can be realized by any circuit if the current can be controlled by the bias voltages Vb1 to Vb6 from the amplifier bias circuit 37. The values of the respective bias voltages Vb1 to Vb, VBIASP, and VBIASN are properly set according to the respective current sources, and may not be identical with each other. Also, the number of bias voltages for controlling the respective constant current sources is not limited to the example in FIG. 5, but can be appropriately selected according to a used circuit.

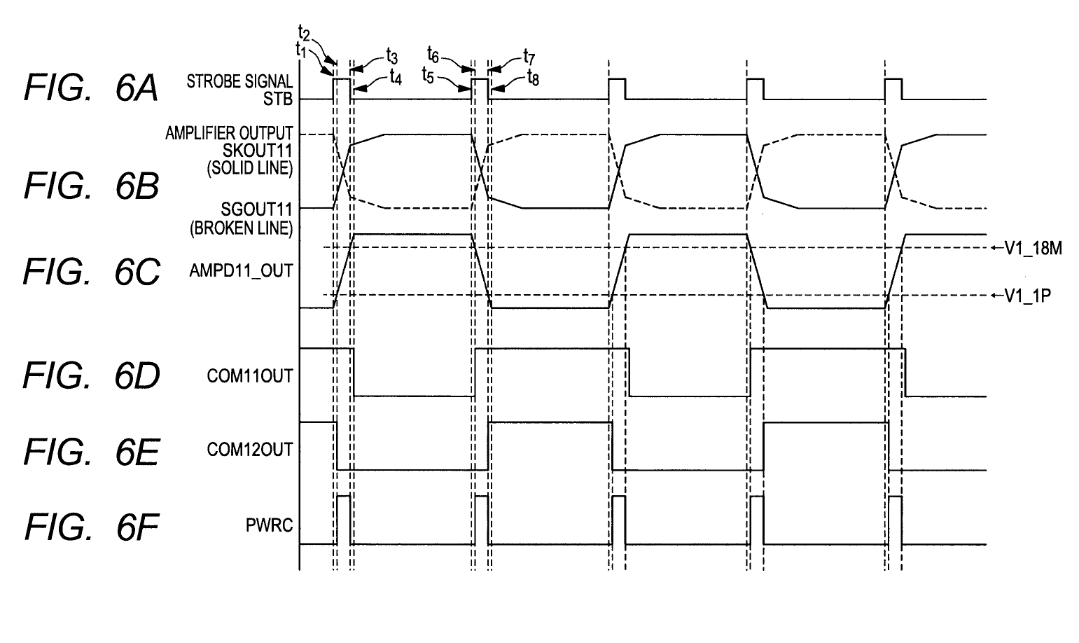

Subsequently, the operation of the source drive in the liquid crystal display device according to the first embodiment of the present invention will be described. FIGS. 6A to 6F are timing charts showing an example of operation of the source driver in the liquid crystal display device according to the first embodiment of the present invention. FIG. 6A shows a strobe signal STB that conducts control so that the amplifier output is coupled to the output terminal at the low level, and the output terminal becomes high impedance at the high level. FIG. 6B shows an output SKOUT11 (solid line) of the odd-numbered output amplifier 22a and an output SGOUT11 (broken line) of the even-numbered output amplifier 22b. FIG. 6C shows an output AMPD11_OUT of the dummy amplifier 32. FIG. 6D shows an output COM11OUT of the comparator 33. FIG. 6E shows an output COM12OUT of the comparator 34. FIG. 6F shows an output PWRC of the EXOR circuit 35.

The operation of the odd-numbered output amplifier 22a will be exemplified in the following description. Let us consider a case in which the output (output SKOUT11(b) indicated by a solid line) of the odd-numbered output amplifier 22a is inverted in polarity upon receiving the strobe signal STB(a) (time t1), and changes from a voltage V1_n (n is any one of 1 to 9) from the negative DA converter 11b to a voltage V1_m (n is any one of 10 to 18) from the positive DA converter 11a. The even-numbered output amplifier 22b (output SGOUT11(b) indicated by a broken line) is contrary to the odd-numbered output amplifier 22a.

At time t1, upon receiving an input of the polarity inverting control signal POL (not shown in FIG. 6), the input switch 31 turns on the switch the highest voltage V1_18, and turns off the switch at the lowest voltage V1_1 side. As a result, the input switch 31 applies the highest voltage V1_18 to the non-inverting input terminal (+) of the dummy amplifier 32. Upon application of the highest voltage V1_18, the dummy amplifier 32 executes the operation of the operational amplification (one times), and outputs the result to the comparators 33 and 34.

At times t1 to t2, the output AMD11_OUT(c) of the dummy amplifier 32 transiently increases from the initial lowest voltage V1_1, but is lower than the voltage V1_1P. For that reason, the output COMP11OUT(d) of the comparator 33 is high level, and the output COMP12OUT(e) of the comparator 34 is high level. As a result, an output RWRC(f) of the EXOR circuit 35 becomes low level. The amplifier bias circuit 37 outputs the bias voltages Vb1 to Vb6, VBIASP, and VBIASN, which provide the low bias, to the output amplifier 22 (the odd-numbered output amplifier 22a and the even-numbered output amplifier 22b) in response to the output PWRC(f) of the EXOR circuit 35. The bias voltage of the low bias is a bias voltage in the normal operation. As a result, the respective constant current sources supply the current (bias current) in the normal operation. In this example, the respective current sources are the constant current sources ICS41, ICS42, ICS43, the floating current source ICS44, and the current mirror circuits 42A, 42B.

At times t2 to t3, the output AMD11_OUT(c) of the dummy amplifier 32 further transiently increases, and becomes a value in a range of from the voltages V1_1P to V1_18M. For that reason, the output COMP11OUT(d) of the comparator 33 is high level, and the output COMP12OUT(e) of the comparator 34 is low level. As a result, the output PWRC(f) of the EXOR circuit 35 becomes high level. The amplifier bias circuit 37 outputs the bias voltages Vb1 to Vb6, VBIASP, and VBIASN, which provide the high bias, to the odd-numbered output amplifier 22a and the even-numbered output amplifier 22b in response to the output PWRC(f) of the EXOR circuit 35. The bias voltage of the high bias is a bias voltage that enables a current larger than the current (bias current) flowing in the normal operation by the respective current sources to flow. In the output amplifier 22 (the odd-numbered output amplifier 22a and the even-numbered output amplifier 22b), the slew rate becomes higher as the bias current is higher. Accordingly, during only a time where the dummy amplifier 32 transits, the bias current of the output amplifier 22 (the odd-numbered output amplifier 22a and the even-numbered output amplifier 22b) increases, thereby making the slew rate higher.

At times t3 to t4, the output AMD11_OUT(c) of the dummy amplifier 32 further transiently increases, exceeds the voltage V1_18M, and reaches the voltage V1_18. For that reason, the output COMP11OUT(d) of the comparator 33 is low level, and the output COMP12OUT(e) of the comparator 34 is low level. As a result, the output PWRC(f) of the EXOR circuit 35 becomes low level. The amplifier bias circuit 37 outputs the bias voltages Vb1 to Vb6, VBIASP, and VBIASN, which provide the low bias, to the odd-numbered output amplifier 22a and the even-numbered output amplifier 22b in response to the output PWRC(f) of the EXOR circuit 35. The bias voltage of the low bias is a bias voltage in the normal operation.

Subsequently, let us consider a case in which the output (output SKOUT11(b) indicated by a solid line) of the odd-numbered output amplifier 22a is inverted in polarity upon receiving the strobe signal STB(a) (time t1), and changes from a voltage V1_m from the positive DA converter 11a to a voltage V1_n from the negative DA converter 11b. As has been already described, the even-numbered output amplifier 22b is contrary to the odd-numbered output amplifier 22a.

At time t5, upon receiving the polarity inverting control signal POL (not shown in FIG. 6), the input switch 31 turns off the switch at the highest voltage V1_18, and turns on the switch at the lowest voltage V1_1. As a result, the input switch 31 applies the lowest voltage V1_1 to the non-inverting input terminal (+) of the dummy amplifier 32. Upon application of the lowest voltage V1_1, the dummy amplifier 32 executes the operation of the operational amplification (one times), and outputs the result to the comparators 33 and 34.

At times t5 to t6, the output AMD11_OUT(c) of the dummy amplifier 32 transiently decreases from the initial lowest voltage V1_18, but is equal to or higher than the voltage V1_18M. For that reason, the output COMP11OUT(d) of the comparator 33 is low level, and the output COMP12OUT(e) of the comparator 34 is low level. As a result, an output RWRC(f) of the EXOR circuit 35 becomes low level. The amplifier bias circuit 37 outputs the bias voltages Vb1 to Vb6, VBIASP, and VBIASN, which provide the low bias, to the odd-numbered output amplifier 22a and the even-numbered output amplifier 22b in response to the output PWRC(f) of the EXOR circuit 35.

At times t6 to t7, the output AMD11_OUT(c) of the dummy amplifier 32 further transiently decreases, and becomes a value in a range of from the voltages V1_1P to V1_18M. For that reason, the output COMP11OUT(d) of the comparator 33 is high level, and the output COMP12OUT(e) of the comparator 34 is low level. As a result, the output PWRC(f) of the EXOR circuit 35 becomes high level. The amplifier bias circuit 37 outputs the bias voltages Vb1 to Vb6, VBIASP, and VBIASN, which provide the high bias, to the odd-numbered output amplifier 22a and the even-numbered output amplifier 22b in response to the output PWRC(f) of the EXOR circuit 35.

At times t7 to t8, the output AMD11_OUT(c) of the dummy amplifier 32 further transiently decreases, drops below the voltage V1_1P, and reaches the voltage V1_1. For that reason, the output COMP11OUT(d) of the comparator 33 is high level, and the output COMP12OUT(e) of the comparator 34 is high level. As a result, the output PWRC(f) of the EXOR circuit 35 becomes low level. The amplifier bias circuit 37 outputs the bias voltages Vb1 to Vb6, VBIASP, and VBIASN, which provide the low bias, to the odd-numbered output amplifier 22a and the even-numbered output amplifier 22b in response to the output PWRC(f) of the EXOR circuit 35.

With the above operation, when the output AMPD11_OUT of the dummy amplifier 32 is between the voltage V1_1P and V1_18M at times t2 to t3, and t6 to t7 (output transition period), the bias of the output amplifier 22 (the odd-numbered output amplifier 22a and the even-numbered output amplifier 22b) is controlled to be high. This operation is a dot inversion. In the description of FIGS. 6A to 6F, it is assumed that the rising time≈the falling time. In the output amplifier 22 (the odd-numbered output amplifier 22a and the even-numbered output amplifier 22b), the slew rate becomes higher as the bias current is higher. Accordingly, during only a time where the dummy amplifier 32 transits, the bias current of the output amplifier 22 (the odd-numbered output amplifier 22a and the even-numbered output amplifier 22b) increases.

The present inventors have obtained the following knowledge through various studies. That is, it is first desirable that a start of the high bias period is at the same time of an output transition start of the dummy amplifier 32 (exemplification: time t1), or after a given time from the output transition start (exemplification: time t2). Also, it is desirable that an end of the high bias period is after the output transition start of the dummy amplifier 32 until the output AMPD11_OUT reaches a voltage (V1_18M or V1_1P) as close as the given voltage V1_18 or V1_1 (exemplification: time t3). When a voltage that sufficiently exceeds the input offset voltage across the comparators 33 and 34 is Vcomoff, it is desirable that V1_18M=V1_18−Vcomoff and V1_1P V1_1+Vcomoff are set to end the high bias period.

The reasons are described below. That is, a period since a charging and discharging start with respect to the phase compensation capacitors C41 and C42 within the output amplifier 22 (the odd-numbered output amplifier 22a and the even-numbered output amplifier 22b) till a charging and discharging end, that is, a period for dominantly determining an inclination of the rising or falling waveform of the amplifier outputs (SKOUT11 and SGOUG11) is necessary and sufficient for the high bias period. Also, the initial state of the transient characteristic of the dummy amplifier 32 which is substantially the same characteristic as that of the output amplifier 22 (the odd-numbered output amplifier 22a and the even-numbered output amplifier 22b) and has no load has substantially no difference from that of the output amplifier 22. Those conditions are reasons that no load may be coupled to the dummy amplifier 32. For that reason, in FIG. 4A, the voltages compared in the comparators 33 and 34 are V1_18M and V1_1P in association with the above conditions.

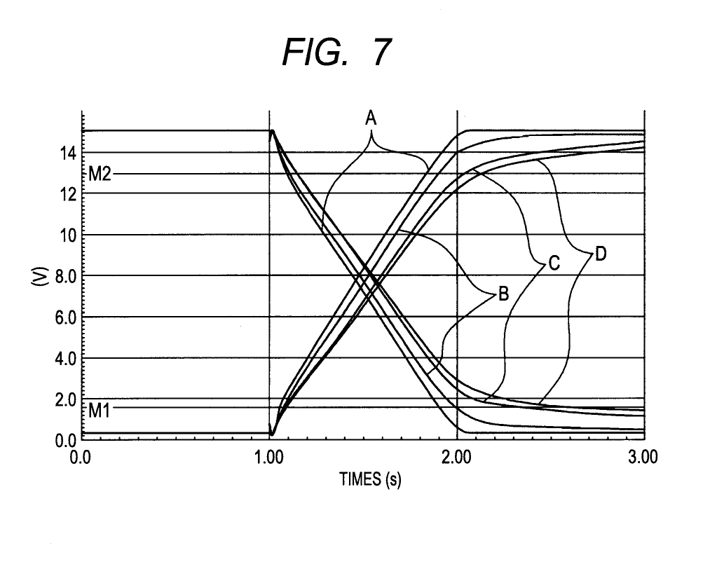

Also, there is advantageous in that the slew rate of the dummy amplifier 32 follows the manufacturing variation of the slew rate of the output amplifier 22. FIG. 7 is a graph showing an initial waveform of a transient characteristic of the output amplifier with a load and an initial waveform of a transient characteristic of the dummy amplifier with no load. The axis of ordinate represents a voltage, and the axis of abscissa represents a time. A curve A is a voltage waveform at an output terminal 24 when there is no load. A curve B is a voltage waveform immediately after amplifier output when a load is 10 kΩ+350 pF. A curve C is a voltage waveform at the output terminal 24 when the load is 10 kΩ+250 pF. A curve D is a voltage waveform at the output terminal 24 when the load is 10 kΩ+350 pF. When a case where there is no load (curve A) is compared with a case where there is a load (curves B, C, D), it is found that there is substantially no difference in the transient characteristic, in particular, the initial characteristic therebetween. Accordingly, it is conceivable that the characteristic of the dummy amplifier 32 required for the bias control circuit 13 is equivalent to the characteristic of the output amplifier 22 coupled to the load even if no load is coupled to the dummy amplifier 32.

As described above, in this embodiment, multiple output signals (Vb1 to Vb6, VBIASP, VBIASN) are supplied from the amplifier bias circuit 37 to the respective output amplifiers 22a and 22b so as to increase the bias current of the output amplifier 22 (the odd-numbered output amplifier 22a, the even-numbered output amplifier 22b) only during a period in which a voltage of the output (input of the amplifier bias circuit 37) PWRC of the EXOR circuit 35 is high level, that is, during a time when the output of the dummy amplifier 32 transits.

In this example, the output amplifier 22 and the dummy amplifier 32 are set to be substantially identical in the electric characteristic with each other (for example, identical in structure and layout). That is, a time when the output of the output amplifier 22 transits and a time when the output of the dummy amplifier 32 transits are substantially identical with each other. Accordingly, the bias current of the output amplifier 22 increases only during the time when the output of the dummy amplifier 32 transits, thereby enabling the bias current to increase only during the time when the output of the output amplifier 22 transits.

Also, in this embodiment, as a preferred embodiment, the dummy amplifier 32 is configured by a dummy amplifier provided for suppressing an increase in the deviation of the output amplifier array. In this case, the configuration of the output amplifier 22 is substantially identical with the configuration (layout) of the dummy amplifier 32. The output amplifier 22 and the dummy amplifier 32 are disposed relatively close to each other. Accordingly, it is conceivable that influences of the manufacturing variation and the deviation on the output amplifier 22 and the dummy amplifier 32 are substantially identical with each other. For that reason, it is conceivable that a deviation of the slew rate and a change in the slew rate due to the bias adjustment in the output amplifier 22 are substantially identical with a deviation of the slew rate and a change in the slew rate due to the bias adjustment in the dummy amplifier 32. Accordingly, the slew rate can be controlled in conformity to the electric characteristic of the output amplifier 22 although the dummy amplifier 32 is used. That is, a time when the bias current accurately increases can be created only during the period where the output of the output amplifier 22 transits without being affected by the manufacturing variation.

Further, the dummy amplifier provided for suppressing an increase in the deviation of the output amplifier array can be used as the dummy amplifier 32 to suppress an increase in the circuit area without a need to newly form a specific element for the dummy amplifier 32.

### Second Embodiment

A description will be given of configures of a source driver for a liquid crystal display device and the liquid crystal display device using the source driver according to a second embodiment of the present invention. This embodiment is different from the first embodiment in not the dot inverting operation but the configuration and operation in the case of a column inverting operation. Hereinafter, the details will be described.

The configuration of the liquid crystal display device according to the second embodiment of the present invention is illustrated in FIG. 3 as in the first embodiment.

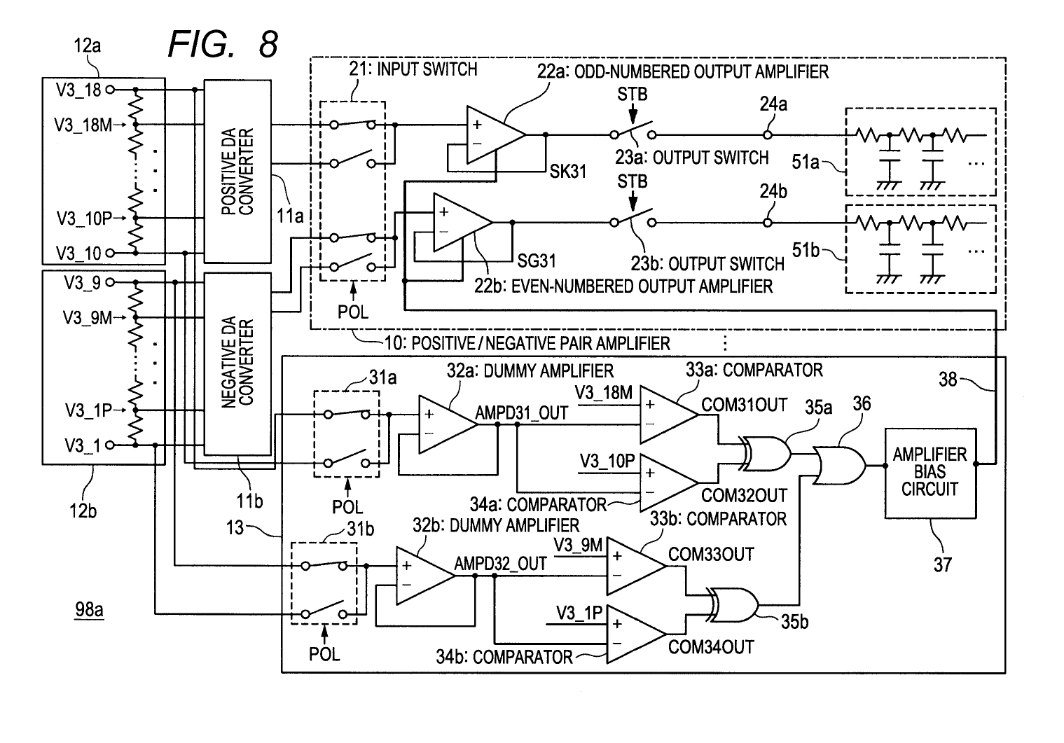

The source driver 98 will be described. FIG. 8 is a block diagram illustrating an example of a configuration of a source driver in a liquid crystal display device according to the second embodiment of the present invention. The source driver 98 is directed to a source driver IC including a positive γ resistor circuit 12a, a negative γ resistor circuit 12b, a positive DA converter 11a, a negative DA converter 11b, a positive/negative pair amplifier 10, and a bias control circuit 13. FIG. 8 illustrates one positive/negative pair amplifier 10 having each odd output amplifier 22a for the odd-numbered data lines 92 and each even output amplifier 22b for the even-numbered data lines 92, together with related circuits. FIG. 8 illustrates the bias control circuit 13 having two sets of the dummy amplifiers and the peripheral circuits in FIG. 4A. FIG. 4A illustrates a column inverting operation.

The positive γ resistor circuit 12a is applied with at least two gamma voltages (exemplification: V3_10, V3_18) from a positive polarity γ correction circuit (not shown), and generates multiple positive reference voltages (exemplification: V3_10 to V3_18) by voltage division. The negative γ resistor circuit 12b is applied with at least two gamma voltages (exemplification: V3_1, V3_9) from a negative polarity γ correction circuit (not shown), and generates multiple negative reference voltages V3_1 to V3_9 by voltage division. The positive DA converter 11a selects positive reference voltages (for normal rotation, for reverse rotation) corresponding to the input video data on the basis of the positive reference voltages applied from the positive γ resistor circuit 12a, and outputs the selected positive reference voltage to the positive/negative pair amplifier 10. The negative DA converter 11b selects negative reference voltages (for normal rotation, for reverse rotation) corresponding to the input video data on the basis of the negative reference voltages applied from the negative γ resistor circuit 12b, and outputs the selected negative reference voltage to the positive/negative pair amplifier 10.

The positive/negative pair amplifier 10 includes an input switch 21, an output amplifier 22 (odd-numbered output amplifier 22a, even-numbered output amplifier 22b), output switches 23a, 23b, and output terminals 24a, 24b. The input switch 21 outputs one of the selected positive reference voltages (for normal rotation, for reserve rotation) to a non-inverting input terminal (+) of the odd-numbered output amplifier 22a, selectively according to a polarity inverting control signal POL. The input switch 21 also outputs one of the selected negative reference voltages (for normal rotation, for reserve rotation) to a non-inverting input terminal (+) of the even-numbered output amplifier 22b, selectively according to the polarity inverting control signal POL. The odd-numbered output amplifier 22a and the even-numbered output amplifier 22b have inverting input terminals (−) SK31 and SG31 coupled to inverting input terminals (−) thereof, respectively. The odd-numbered output amplifier 22a and the even-numbered output amplifier 22b operationally amplify the positive reference voltage and the negative reference voltage applied thereto, respectively. The odd-numbered output amplifier 22a and the even-numbered output amplifier 22b then output those results as outputs SKOUT11 and SGOUT11 to display panel loads 51a and 51b (corresponding to the liquid crystal panels 96) from the output terminals 24a and 24b through the output switches 23a and 23b. The output switches 23a and 23b are controlled according to the strobe signal STB (a signal that conducts control so that the amplifier output is coupled to the output terminal at a low level, and the output terminal becomes high impedance at a high level). The odd-numbered output amplifier 22a and the even-numbered output amplifier 22b have the bias voltages controlled by the bias control circuit 13. The odd-numbered output amplifier 22a and the even-numbered output amplifier 22b are substantially identical in the electric characteristic and structure (layout) with each other.

The bias control circuit 13 controls multiple bias voltages to be applied to the odd-numbered output amplifier 22a and the even-numbered output amplifier 22b on the basis of the reference voltages from the positive γ resistor circuit 12a and the negative γ resistor circuit 12b, and the polarity inverting control signal POL from the controller 95. The bias control circuit 13 includes input switches 31a, 31b, a dummy amplifier 32a, comparators 33a, 34a, an EXOR circuit 35a, an input switch 31b, a dummy amplifier 32b, comparators 33b, 34b, an EXOR circuit 35b, an OR circuit 36, and an amplifier bias circuit 37.

The input switch 31a is applied with the highest voltage V3_18 and the lowest voltage V3_10 among the reference voltages of the positive γ resistor circuit 12a. The input switch 31a alternately outputs the highest voltage V3_18 and the lowest voltage V3_10 to the non-inverting input terminal (+) of the dummy amplifier 32a, switchingly in the cycle of the polarity inverting control signal POL. The input switch 31b is applied with the highest voltage V3_9 and the lowest voltage V3_1 among the reference voltages of the negative γ resistor circuit 12b. The input switch 31b alternately outputs the highest voltage V3_9 and the lowest voltage V3_1 to the non-inverting input terminal (+) of the dummy amplifier 32b, switchingly in the cycle of the polarity inverting control signal POL.

The dummy amplifier 32a is alternately applied with the highest voltage V3_18 and the lowest voltage V3_10 in the cycle of the polarity inverting control signal POL. The dummy amplifier 32a operationally amplifies the applied voltage, and outputs a resultant output AMPD31_OUT to inverting input terminals (−) of the comparators 33a and 34a. The dummy amplifier 32a has an output terminal coupled to the inverting input terminal (−) thereof. The dummy amplifier 32a has the same electric characteristic with that of the output amplifier 22 (the odd-numbered output amplifier 22a, the even-numbered output amplifier 22b) as in the first embodiment. In order to provide the same electric characteristic, it is preferable that the dummy amplifier 32a has the same structure (layout) as that of the output amplifier 22. In addition, it is more preferable that the dummy amplifier 32a is disposed in the vicinity of the output amplifier 22.

The dummy amplifier 32b is alternately applied with the highest voltage V3_9 and the lowest voltage V3_1 in the cycle of the polarity inverting control signal POL. The dummy amplifier 32b operationally amplifies the applied voltage, and outputs a resultant output AMPD32_OUT to inverting input terminals (−) of the comparators 33b and 34b. The dummy amplifier 32b has an output terminal coupled to the inverting input terminal (−) thereof. The dummy amplifier 32b has the same electric characteristic with that of the output amplifier 22 (the odd-numbered output amplifier 22a, the even-numbered output amplifier 22b) as in the first embodiment. In order to provide the same electric characteristic, it is preferable that the dummy amplifier 32b has the same structure (layout) as that of the output amplifier 22. In addition, it is more preferable that the dummy amplifier 32b is disposed in the vicinity of the output amplifier 22.

The comparator 33a has an inverting input terminal (−) applied with an output of the dummy amplifier 32a, and a non-inverting input terminal (+) applied with a voltage (V3_18M) slightly lower than the highest voltage V3_18, respectively. The comparator 33a then outputs an output COM31OUT as the comparison result to one input of the EXOR circuit 35a. On the other hand, the comparator 34a has an inverting input terminal (−) applied with an output of the dummy amplifier 32a, and a non-inverting input terminal (+) applied with a voltage (V3_10P) slightly higher than the lowest voltage (V3_10), respectively. The comparator 34a then outputs an output COM32OUT as the comparison result to the other input of the EXOR circuit 35a.

The comparator 33b has an inverting input terminal (−) applied with an output of the dummy amplifier 32b, and a non-inverting input terminal (+) applied with a voltage (V3_9M) slightly lower than the highest voltage (V3_9), respectively. The comparator 33b then outputs an output COM33OUT as the comparison result to one input of the EXOR circuit 35b. On the other hand, the comparator 34b has an inverting input terminal (−) applied with an output of the dummy amplifier 32b, and a non-inverting input terminal (+) applied with a voltage (V3_1P) slightly higher than the lowest voltage (V3_1), respectively. The comparator 34b then outputs an output COM34OUT as the comparison result to the other input of the EXOR circuit 35b.

The EXOR circuit 35a has two inputs, and is applied with the outputs COM31OUT and COM32OUT of the comparators 33a and 34a. The EXOR circuit 35a executes EXORing of the outputs COM31OUT and COM32OUT. The EXOR circuit 35a outputs an operation result to one input of the amplifier bias circuit 36. The EXOR circuit 35b has two inputs, and is applied with the outputs COM33OUT and COM34OUT of the comparators 33b and 34b. The EXOR circuit 35b executes EXORing of the outputs COM33OUT and COM34OUT. The EXOR circuit 35b outputs an operation result to the other input of the amplifier bias circuit 36.

The OR circuit 36 ORs the outputs of the EXOR circuit 35a and the EXOR circuit 35b. The OR circuit 36 then outputs an output PWRC as the operation result to the amplifier bias circuit 37.

When at least one of the following conditions (1) and (2) is satisfied, the amplifier bias circuit 37 controls both of the odd-numbered output amplifier 22a and the even-numbered output amplifier 22b to be high in bias. (1) A condition where the output AMPD31_OUT of the dummy amplifier 32a is between the voltage V3_18M and the voltage V3_10P, that is, a condition where the output COM31OUT is high level, and the output COM32OUT is low level, whereby the output PWRC of the OR circuit 36 becomes high level. (2) A condition where the output AMPD32_OUT of the dummy amplifier 32b is between the voltage V3_9M and the voltage V3_1P, that is, a condition where the output COM33OUT is high level, and the output COM34OUT is low level, whereby the output PWRC of the OR circuit 36 becomes high level.

On the other hand, when at least one of the following conditions (3) and (4) is satisfied, the amplifier bias circuit 37 controls both of the odd-numbered output amplifier 22a and the even-numbered output amplifier 22b to be low in bias. (3) A condition where the output AMPD31_OUT of the dummy amplifier 32a is larger than the voltage V3_18M or smaller than the voltage V3_10P, that is, a condition where the output COM31OUT is low level, and the output COM32OUT is low level, or the output COM31OUT is high level, and the output COM32OUT is high level whereby the output PWRC of the OR circuit 36 becomes low level. (4) A condition where the output AMPD32_OUT of the dummy amplifier 32b is larger than the voltage V3_9M or smaller than the voltage V3_1P, that is, a condition where the output COM33OUT is low level, and the output COM34OUT is low level, or the output COM33OUT is high level, and the output COM34OUT is high level whereby the output PWRC of the OR circuit 36 becomes low level. The above sequential operation is a column inverting operation.

It is preferable to use, as the dummy amplifiers 32a and 32b, the dummy amplifier which is arranged at both ends of an output amplifier array for the purpose of preventing a deviation enlargement caused by the output amplifier array of the source driver part. The dummy amplifier is entirely identical in circuit configuration and layout configuration with the output amplifier 22. That is, the dummy amplifier has the same electric characteristic as that of the output amplifier 22. Further, the dummy amplifier is disposed in the vicinity of the output amplifier 22. In addition, the dummy amplifier can be effectively used to suppress an increase in the circuit area. This is the same as that in the dummy amplifier 32 according to the first embodiment described with reference to FIG. 4B.

Also, the amplifier bias circuit 37 may be divided into an amplifier bias circuit for controlling the odd-numbered output amplifier 22a, and an amplifier bias circuit for controlling the even-numbered output amplifier 22b, or may have those two functions. In this case, the amplifier bias circuit for controlling the odd-numbered output amplifier 22a controls the odd-numbered output amplifier 22a according to an output from the EXOR circuit 35a as in the same manner as that of the first embodiment. The amplifier bias circuit for controlling the even-numbered output amplifier 22b controls the even-numbered output amplifier 22b according to an output from the EXOR circuit 35b as in the same manner as that of the first embodiment.

An example of the configuration of the output amplifier according to the second embodiment of the present invention is illustrated in FIG. 5 as in the first embodiment.

The operation of the source driver in the liquid crystal display device according to the second embodiment of the present invention is shown in FIGS. 6A to 6F as in the first embodiment except that the circuits (two input switches, two dummy amplifiers, two comparators, EXOR circuit) that output the timing signals for controlling the bias voltages, independently, are provided to the respective odd-numbered output amplifier 22a and even-numbered output amplifier 22b, and the reference voltages of the comparators are different. Similarly, in this case, a description is given assuming that rising time≈falling time.

Similarly, in this embodiment, the same advantages as those in the first embodiment can be obtained. Also, the rising time of the column inverting operation may not be balanced with the falling time from the viewpoint of designing the output amplifier. As in this embodiment, the outputs of the two EXOR circuits pass through the OR circuit whereby a time for increasing the bias current can be created by the amplifier output slower in the transition time. As a result, even if the rising time is not balanced with the falling time between the odd-numbered output amplifier and the even-numbered output amplifier within the positive and negative pair amplifier, a more stable transition time can be set.

In the respective embodiments of the present invention, in the operation of the differential amplifier of the source driver IC for the liquid crystal display device, the dummy amplifier 32 is provided to operate with specific amplitude (from V1_18 to V1_10 and from V1_9 to V1_1, or from V3_18 to V3_10, and from V3_9 to V3_1). The bias current of the output amplifier 22 is increased in a period when the output of the dummy amplifier 32 transits under the control. In this situation, the dummy amplifier 32 has the same electric characteristic as that of the output amplifier 22. As a result, the dummy amplifier 32 increases the bias current at the output amplifier 22 only in a period following the output transition of the output amplifier 22 so as to provide the higher slew rate. Also, since the period during which the bias current increases is limited, an increase in the dynamic power consumption caused by the higher slew rate can be suppressed.

Also, the electric characteristic may include a deviation from the design of the electric characteristic caused by the manufacturing variation. That is, with the provision of the dummy amplifier 32 in the vicinity of the output amplifier 22, the manufacturing variation of the dummy amplifier 32 can be made identical with the manufacturing variation of the output amplifier 22. As a result, with the use of the output transition period of the dummy amplifier 32, the bias current increases only during the period following the slew rate variation caused by the manufacturing variation of the output amplifier 22, the higher slew rate can be provided, and the dynamic power consumption can be decreased.

In the present invention, the substantially necessary and sufficient high bias control can be conducted. This is achieved by use of the output transition period of the dummy amplifier which is equivalent to the output transition period of the output amplifier required to conduct the high bias control as the control time, and by use of the largest gradation voltage and the lowest gradation voltage which are largest in change as the gradation voltages (a change width of the gradation voltage) to be controlled. Also, in the present invention, useless dynamic power consumption can be prevented from increasing. This is achieved by conducting the substantially necessary and sufficient high bias control as described above. Also, in the present invention, the high bias control following the slew rate variation due to the manufacturing variation (inside of source driver IC or among the ICs) of the output amplifier can be conducted.

The present invention is not limited to the above respective embodiments, but it is apparent that the respective embodiments can be appropriately deformed or changed without departing from the technical concept of the present invention. Also, the technique disclosed in the respective embodiments can be applied to other embodiments so far as there is no technical contradiction.

What is claimed is:

1. A source driver for a liquid crystal display device, comprising:
a plurality of output amplifiers that drive a plurality of data lines in response to an input signal; and
a bias control circuit having a dummy amplifier consistent with an electric characteristic of the output amplifiers,
wherein the bias control circuit controls a period during which the output amplifiers are set to high biases, on the basis of a transition period of an output from the dummy amplifier when the dummy amplifier receives voltages of a γ resistor circuit, which are input to the output amplifiers.

2. The source driver for a liquid crystal display device according to claim 1, wherein the dummy amplifier is substantially identical in layout with the output amplifiers.

3. The source driver for a liquid crystal display device according to claim 1, wherein the transition period is a period for dominantly determining inclinations of rising and falling waveforms.

4. The source driver for a liquid crystal display device according to claim 1,
wherein the bias control circuit includes:
a first dummy amplifier as the dummy amplifier which receives the highest voltage and the lowest voltage of the γ resistor circuit, which are input to the output amplifiers, switchingly in the same strobe signal period as that of the output amplifiers;
a first comparator having an inverting input that receives an output of the first dummy amplifier, and a non-inverting input that receives a voltage smaller than the highest voltage of the γ resistor circuit by a given voltage;
a second comparator having an inverting input that receives the output of the first dummy amplifier and a non-inverting input that receives a voltage larger than the lowest voltage of the γ resistor circuit by a given voltage;
a logical operation circuit that receives outputs of the first comparator and the second comparator; and
an amplifier bias circuit that receives an output of the logical operation circuit,
wherein the period during which the output amplifiers are set to high biases according to the output of the amplifier bias circuit is controlled.

5. The source driver for a liquid crystal display device according to claim 4,
wherein the gradation voltage for controlling the period for setting the high bias is conducted when outputting a gradation voltage that exceeds a voltage (Vmax−Vcomoff) slightly lower than the highest voltage Vmax of the γ resistor circuit by a voltage Vcomoff sufficiently exceeding an input offset voltage of the first comparator and the second comparator, and/or when outputting a gradation voltage slightly lower than the lowest voltage Vmin of the γ resistor circuit by a voltage (Vmin+Vcomoff) slightly higher than Vcomoff.

6. The source driver for a liquid crystal display device according to claim 4,
wherein the first comparator outputs a first comparison result of the highest voltage of a positive γ resistor circuit in the γ resistor circuit, which is output from the first dummy amplifier, and a voltage slightly lower than the highest voltage of the positive γ resistor circuit,
wherein the second comparator outputs a second comparison result of the lowest voltage of a negative γ resistor circuit in the γ resistor circuit, which is output from the first dummy amplifier, and a voltage slightly higher than the lowest voltage of the negative γ resistor circuit,
wherein the logical operation circuit outputs a result of logical operation based on the first comparison result and the second comparison result, and
wherein the amplifier bias circuit controls the period for setting the high bias on the basis of the result of the logical operation.

7. The source driver for a liquid crystal display device according to claim 4,
wherein the bias control circuit further includes:
a second dummy amplifier as the dummy amplifier which receives the highest voltage and the lowest voltage of the γ resistor circuit, which are input to the output amplifiers, switchingly in the same strobe signal period as that of the output amplifiers;
a third comparator having inverting input that receives an output of the second dummy amplifier, and a non-inverting input that receives a voltage smaller than the highest voltage of the γ resistor circuit by a given voltage;
a fourth comparator having an inverting input that receives the output of the second dummy amplifier and a non-inverting input that receives a voltage larger than the lowest voltage of the γ resistor circuit by a given voltage,
wherein the logical operation circuit that receives outputs of the first comparator, the second comparator, the third comparator, and the fourth comparator.

8. The source driver for a liquid crystal display device according to claim 7,
wherein the first comparator outputs a first comparison result of the highest voltage of a positive γ resistor circuit in the γ resistor circuit, which is output from the first dummy amplifier, and a voltage slightly lower than the highest voltage of the positive γ resistor circuit,
wherein the second comparator outputs a second comparison result of the lowest voltage of the positive γ resistor circuit, which is output from the first dummy amplifier, and a voltage slightly higher than the lowest voltage of the positive γ resistor circuit,
wherein the third comparator outputs a third comparison result of the highest voltage of a negative γ resistor circuit in the γ resistor circuit, which is output from the second dummy amplifier, and a voltage slightly lower than the highest voltage of the negative γ resistor circuit,
wherein the fourth comparator outputs a fourth comparison result of the lowest voltage of the negative γ resistor circuit, which is output from the second dummy amplifier, and a voltage slightly higher than the lowest voltage of the negative γ resistor circuit,
wherein the logical operation circuit outputs a result of logical operation based on the first comparison result, the second comparison result, the third comparison result, and the fourth comparison result, and
wherein the amplifier bias circuit controls the period for setting the high bias on the basis of the result of the logical operation.

9. A liquid crystal display device comprising:
the source driver for the liquid crystal display device according to claim 1;
a plurality of data lines driven by the source driver for the liquid crystal display device; and
a plurality of pixels coupled to the data lines.
